(19) United States
(12) Patent Application Publication
(10) Pub. No.: US 2013/0031589 A1
(43) Pub. Date: Jan. 31, 2013

(54) MULTIPLE RESOLUTION SCANNABLE VIDEO

(71) Applicants: Xavier CASANOVA, San Jose, CA (US); Walter Rezin MANN, San Francisco, CA (US)

(72) Inventors: Xavier CASANOVA, San Jose, CA (US); Walter Rezin MANN, San Francisco, CA (US)

(21) Appl. No.: 13/473,370

(22) Filed: May 16, 2012

Related U.S. Application Data
(60) Provisional application No. 61/512,395, filed on Jul. 27, 2011.

(51) Int. Cl. H04N 21/258

(52) U.S. Cl. 725/93; 725/91

(57) ABSTRACT

To enable a user to rapidly scan to a desired frame of a video, multiple recordings of the video are provided, each at progressively better resolution. When the user is scanning for a frame, the lowest resolution recording is used to provide the display; when the user arrives at a desired frame, the higher resolution recordings are used. A subsequent user selection of a different frame causes the display of the higher resolution images to be interrupted, and the lowest resolution recording is used to provide an image corresponding to the different frame. The lesser resolution recordings may include a reduction in either spatial or temporal resolution, or both, and may include ‘motion blur’ that provides a visually ‘smoother’ continuous scan. Each higher resolution frame replaces the lower resolution frame that is displayed while waiting for the higher resolution frame to be downloaded.

This application claims the benefit of U.S. Provisional Patent Application 61/512,395, filed 27 Jul. 2011.

### BACKGROUND AND SUMMARY OF THE INVENTION

This invention relates to the field of video presentation, and in particular to a method and system that supports a user-controllable scan of frames within the video.

The ever increasing use of mobile devices with interactive graphic capabilities, such as Internet-enabled tablets and smart-phones, has created unprecedented opportunities that take advantage of interactive video presentations. In product advertising, video advertisements may be provided that allow a user to ‘tour’ the product, including capabilities for viewing the product from different viewing angles. In social networking, users can create “360° views” of their surroundings and enable friends to interact with these views, often while interacting with the user. In military and surveillance applications, interaction with such panoramic views may significantly enhance situational awareness.

The interaction with such video recordings is greatly enhanced when the user is able to scan to any particular view of the object or scene as quickly as desired. That is, to provide a realistic interaction, the user should feel in complete control of the viewing angle, much like controlling the video camera that created the video. That is, merely providing a ‘scan left’, ‘scan right’, ‘quick-scan left’, ‘quick-scan right’ selection may not provide for a realistic interaction, because it does not allow, for example, for the person to ‘instantly turn around’, or ‘instantly turn the object around’.

Conventional video playback devices, such as a DVR (Digital Video Recorder) often include a ‘scrubber’ bar on a touch pad or screen that allows a user to slide a pointer along the bar to skip ahead or back to any portion of the video. That is, at the beginning of the video, the pointer may be at the far left of the bar, indicating the beginning of the video; moving the pointer to the far right of the bar will advance the video to its last frame; moving the pointer to the middle of the bar will advance the video to a frame near its mid-point; and so on. Other variations of this concept include a ‘speed’ bar, wherein at a center point on the bar, the video is in ‘still’ mode; moving the pointer to the right causes the video to be played forward, moving it to the left causes the video to be played in reverse. The further the pointer is moved to the right or left, the faster the video is played back. In this manner, the user can quickly advance the video forward or back, then ‘fine-tune’ the forward and reverse playback until the desired frame is located.

In these conventional video playback devices, providing a ‘smooth’ advancement of the video is difficult, because not every frame is directly available for decoding and display. Video compression techniques, such as MPEG for example, use a differential encoding, wherein subsequent frames are encoded based on differences between these frames and prior (or future) ‘base’ frames. In order to decode such a differentially encoded frame, the base frame(s) and any intermediate frames associated with the differentially encoded frame must be decoded. This multi-frame decoding is a time consuming process that does not allow for the aforementioned need for rapidly advancing the video playback. Accordingly, the accelerated playback on conventional video playback devices is “choppy”, because only selected base frames are displayed.

This choppy accelerated playback may not be overly objectionable on a video playback device, because once the base frame of the approximate scene is found, the video continues smoothly at the normal playback speed. In an interactive video application, on the other hand, such as a 360° viewing of an object or scene, there is no ‘normal playback speed’ per se; the interactive user scans to a desired viewing angle, then views the ‘still’ image of the object or scene from that viewing angle. If, as in the case of a conventional video playback device, only base frames are displayed during the scanning process, the interactive user would need to find a nearby base frame, then ‘single step’ through the subsequent differentially decoded frames until the desired viewing angle is found.

Even if a choppy accelerated playback were acceptable in an interactive video application, the principles used in conventional playback devices rely on the content of the video being available on demand, either from memory or from a local disc drive. While downloading material to a DVR, for example, only the material that has already been downloaded is available for viewing, and the downloading occurs in a sequential manner, from the beginning to the end of the video recording. It is impossible to advance to the middle of a video on a DVR that is still downloading the beginning of the video.

In an interactive video application, on the other hand, the concept of ‘sequentiality’ is often inappropriate. In a 360° viewing of an object or scene, there is no predefined ‘beginning’ or ‘end’ of the view. Unlike a recording of a movie, the order in which the individual frames of the object or scene are recorded on the video should have no bearing on the order in which these individual frames may be viewed. If the first presented view of the object or scene, for example, is not the user's desired view, the user will expect to be able to select any alternative view, even if that view happened to have been the last view that was captured in the video.

It would be advantageous to provide a method and system for an interactive video application that allows for a rapid selection of a desired frame of the video. It would also be advantageous if the rapid selection process provided a relatively continuous scan of the frames of the video. It would also be advantageous if the relatively continuous scan of the frames occurred at a user-controlled speed.

These advantages, and others, can be realized by providing multiple recordings of an object or scene, each at progressively better resolution. When the user is scanning for a particular view, the lowest resolution recording is used to provide the displayed images; when the user arrives at a frame that provides the desired view, the higher resolution recordings are used. A subsequent user selection of a different view causes the display of the higher resolution images to be interrupted, and the lowest resolution recording is again used to provide an image corresponding to the different view. The lesser resolution recordings may include a reduction in either spatial or temporal resolution, or both, and may include ‘motion blur’ that provides a visually ‘smoother’ continuous scan. Each higher resolution image replaces the lower resolution image that is displayed while waiting for the higher resolution frame(s) to be downloaded. A background process continues to download remaining frames of the recordings of the object or scene while the selected images or views are being displayed.

### BRIEF DESCRIPTION OF THE DRAWINGS

The invention is explained in further detail, and by way of example, with reference to the accompanying drawings wherein:

FIGS. 1A-1C illustrate aspects of an example interactive video application for viewing an object.

FIG. 2 illustrates an example system diagram for the presentation of an interactive video application in accordance with aspects of this invention.

FIGS. 3A-3C illustrate example flow diagrams for the presentation of an interactive video application in accordance with aspects of this invention.

Throughout the drawings, the same reference numerals indicate similar or corresponding features or functions. The drawings are included for illustrative purposes and are not intended to limit the scope of the invention.

### DETAILED DESCRIPTION

In the following description, for purposes of explanation rather than limitation, specific details are set forth such as the particular architecture, interfaces, techniques, etc., in order to provide a thorough understanding of the concepts of the invention. However, it will be apparent to those skilled in the art that the present invention may be practiced in other embodiments, which depart from these specific details. In like manner, the text of this description is directed to the example embodiments as illustrated in the Figures, and is not intended to limit the claimed invention beyond the limits expressly included in the claims. For purposes of simplicity and clarity, detailed descriptions of well-known devices, circuits, and methods are omitted so as not to obscure the description of the present invention with unnecessary detail.

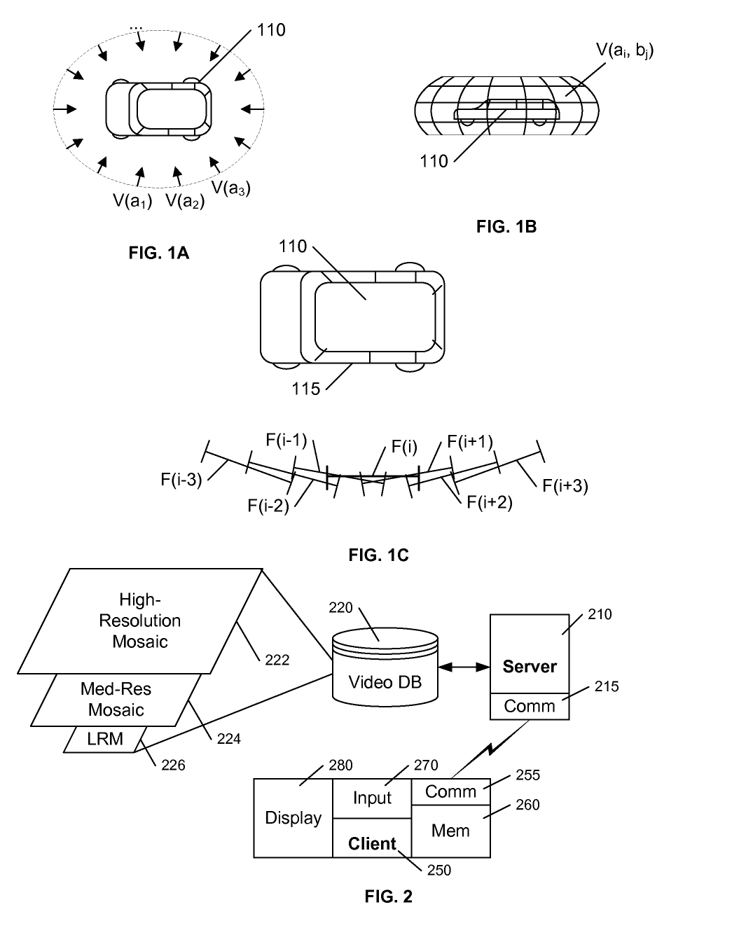

The invention is presented in the context of a viewing of an object from user-selectable viewing angles, as illustrated in the example of FIG. 1A. In this example application, the user is provided with a control device, such as the aforementioned “scrub bar” to enable a control of the view V from different viewing angles (a₁, a₂, a₃, etc.), at a relatively constant distance away from the object 110 being presented for viewing. For convenience, the term ‘orientation’ may be used herein to refer to this viewing angle with respect to a reference position of the object being viewed. One of skill in the art will recognize, however, that the range of control of the viewing angle is only limited by the range of the angles used during the video recording of the object. For example, as illustrated in FIG. 1B, if images from different elevations as well as different orientations are recorded, the user would be provided with a control device, such as a joystick, to able viewing the object 110 at such different orientations (aᵢ) and elevation angles (bⱼ).

One of skill in the art will recognize that the principles of this invention may be used for “looking out” on a scene as well as for “looking in” on an object. For ease of presentation and understanding, the term “object” is used herein in its most general sense, including scenes. That is, if in the example of FIGS. 1A-1C, the user/viewer is at the location of the object 110, and is looking outward, the views V(a₁), V(a₂), etc. would be in the opposite direction as shown, and the “object” being viewed would be the external elements within view of the viewer at each of the particular viewing angles.

In like manner, one of skill in the art will recognize that although this invention is presented in the context of a ‘surround’ view, or a ‘global’ view, the principles of this invention can be applied in simpler applications, such as a linear view, wherein the user's view moves, for example, along a single axis, with a given start and stop location. Other scenarios, such as views along two axis with or without a continuum of location in either direction, may also be supported by embodiments of this invention.

To enable the viewing from different viewing angles, a video is created that provides a plurality of images corresponding to the view of the object 110 at progressively different viewing angles, as illustrated in FIG. 1C. The data corresponding to each image is stored as a frame F of the video; as the user ‘scans’ left or right, the images from different frames are displayed. That is, what appears to the user as a change of viewing angle is a change to the frame that is being displayed. In the example of FIG. 1C, the display of frame F(i) will appear to be a view that is centered and perpendicular to the side 115 of the object 110. The display of frame F(i+1) will appear to be a view that is to the right of center and slightly off the perpendicular, while the display of frame F(i−1) will appear to be a view that is to the left of center and slightly off the perpendicular. In like manner, F(i+2) and F(i+3) are views that are increasingly to the right of center and increasingly off the perpendicular, and F(i−2) and F(i−3) are views that are increasingly to the left of center. Thus, by changing the frame that is being displayed, the user's perception is that the orientation of the viewpoint relative to the object, or the object relative to the viewpoint, is changing.

The term ‘video’ as used herein is intended in a most general sense to include a recording of a plurality of related images. Because the principles of this invention are particularly well suited for facilitating scanning to a particular image in a video, and displaying that image, without necessarily automatically progressing to subsequent images for a ‘motion’ playback, the term ‘mosaic’ is used herein to convey the concept that each image in the video is a distinct entity that is related to other images on the video by spatial proximity to the other images in the context of the entire collection of the images, rather than the more common concept that each image in the video is related to the other images by temporal proximity. That is, in a mosaic video, a ‘next’ image is an ‘adjacent’ image, or an ‘offset’ image in space, whereas in a motion video, a ‘next’ image is a ‘subsequent’ image in time. For ease of reference, the term ‘adjacent’ as used herein does not necessarily imply an edge-to-edge adjacency, and includes adjacent frames that are spatially offset from each other by less than the entire image-width of the frames. For example, in FIG. 1C, frame F(i) is defined herein as being adjacent to each of frames F(i−1) and F(i+1).

The term ‘frame’ is intended to refer to a recording of each image. For ease of presentation, the displayed image in the example embodiment will correspond to the data that is contained within a frame, although one of skill in the art will recognize that a displayed image may correspond to a portion of the data from a frame, or a combination of data from multiple frames. For example, if the user desires to ‘zoom in’ to a particular feature on the object, only a portion of the data from a frame may be used to provide the displayed image; if the user desires to ‘zoom out’, the displayed image may include data from multiple frames. In like manner, if the user's desired view differs from the boundaries of the framed images, the displayed view may include portions of the data from each of the frames corresponding to the desired view. Alternatively stated, the recorded frame that is obtained by the scan of the object in an embodiment of this invention may contain some or all of the data that is used to form the image that is displayed to the user.

The term ‘mosaic section’ as used herein generally refers to a set of spatially related frames within a given mosaic, although it may also refer to a single frame. Alternatively stated, a mosaic section is a subset of the entire view of the object. The size and shape of a mosaic section may be dynamically defined, depending upon the particular application or use of the section. For example, if the user has ‘zoomed out’, the size and shape of the mosaic section may include the frames required to create the zoomed out image. In like manner, as detailed further below, for data access efficiency, a request for a frame of a mosaic may cause a mosaic section to be downloaded, so that subsequent requests for adjacent frames may be satisfied without incurring the overhead associated with initiating a new download. Typically, the size and shape of the downloaded mosaic section will be determined based on such factors as the downloading bandwidth, the size of each frame, the user's prior pattern of requests, and so on.

In a preferred embodiment of this invention, recordings of the object are made at different resolutions, each recording being referred to as a mosaic of the object of interest at the particular resolution (e.g. a high-resolution mosaic, a medium-resolution mosaic, and so on). Typically, a highest resolution recording of the object is captured and stored as the highest resolution mosaic; a lower resolution mosaic is created by extracting and/or creating lower resolution frames from the frames of a higher resolution mosaic.

The resolutions among the different mosaics may vary in a variety of aspects, such as space, time, quality, and so on. A spatial resolution may be specified in terms of the number of individual pixel elements (pixels) in each dimension (length and width) of each recorded image (before compression, if any). A high spatial resolution allows for the display of fine detail in the image. A temporal resolution may be specified in terms of the number of images recorded per unit time, which is generally equivalent to the number of images that are intended to be displayed per unit time during a motion playback at the recorded speed. A high temporal resolution allows for a visually continuous playback, without discernable discontinuities between images. A quality resolution may refer to the degree of accuracy achievable in the recreation of individual elements of the image, and may be specified in terms of the number of bits used to represent each pixel in the image.

As the term “resolution” implies, a higher resolution allows for ‘resolving’ the original image from the recorded image with fewer visual artifacts than a lower resolution. Other parameters may be correlated to the ability to recreate the original image without introducing visual artifacts. Accordingly, in the context of this disclosure, variations in the values of these parameters may be considered to be variations in the resolution of the recorded image. For example, different compression/decompression and encoding/decoding schemes will produce different degrees of loss, some schemes being lossless (zero loss), and other schemes having larger non-zero losses. A recording using a lossless compression/encoding will be considered to be of higher resolution than a compression/encoding that introduces losses.

In the context of a mosaic video, the temporal resolution may be considered to be the total number of images that are available for display during an automated playback of the entire video in a fixed amount of time. That is, in addition to allowing a user to view an object from any orientation, the system may be configured to present a continuously changing view of the object, completing each viewing every N seconds. In this example, if the mosaic includes M images, the temporal resolution would be M/N images per second. Optionally, a measure of the temporal resolution may merely be specified in terms of the total number of images (M) of the object recorded at different views; the larger the number of images, the slower the image can be viewed without discontinuities.

To facilitate presentation and understanding, an example embodiment is presented wherein the object of interest is recorded as a set of three mosaics: a low-resolution mosaic, a medium-resolution mosaic, and a high-resolution mosaic. Frames or sections of these mosaics are then made available for download from a server, such as a vendor's website, to a client, such as a tablet or smart-phone. One of skill in the art will recognize that the number of different levels of resolution is a matter of choice, as is the choice of which types of resolution differences (spatial, temporal) are used for each of these levels.

In this example embodiment, the high-resolution mosaic possesses a spatial resolution that enables a user to view an object to a given level of detail without excessive distortion ('blocks') along edges, a temporal resolution that enables a presentation of a continuously changing view of the object over a given amount of time without visual discontinuities between displayed images, and a quality resolution that accurately reflects the true color and luminance of each element in the image.

In this example embodiment, the spatial resolution of the high-resolution mosaic is about 600×600 pixels, the temporal resolution is about 1000 images (allowing for a thirty second presentation at about 33 frames per second), and the quality resolution is about 24 bits (3 bytes) per pixel (eight bits for each of the colors red, green, and blue).

The example medium-resolution mosaic has the same temporal resolution (1000 frames), but a reduced spatial resolution, such as 300×300 pixels, and a reduced quality resolution, such as two bytes per pixel. The low-resolution mosaic is reduced in both spatial and temporal resolution, such as 200×200 pixels and about 200 images of the object, but maintains the same medium-quality resolution of two bytes per pixel.

Using these example mosaics, the high-resolution mosaic will include, in uncompressed form, about 1 GB (600*600 pixels/frame*3 bytes/pixel*1000 frames); the medium-resolution mosaic will include about 180 MB (300*300 pixels/frame*2 bytes/pixel*1000 frames); and the low-resolution mosaic will include about 16 MB (200*200 pixels/frame*2 bytes/pixel*200 frames). The actual sizes of the recordings will be dependent upon the compression and encoding schemes used, but this example illustrates that reductions in size by an order of magnitude at each resolution level would be easily achievable.

Accordingly, assuming that the time required to obtain and display an image is proportional to the size of the encoding of the image, an increase in speed by two orders of magnitude may be achieved by displaying images from the low-resolution mosaic, as compared to displaying images from the high-resolution mosaic. Obviously, the quality of the displayed images from the low-resolution mosaic will be significantly poorer than the quality of the corresponding image from the high-resolution mosaic, but if the low-resolution image is only displayed for a short period of time, this poorer quality may not be noticeable. Of particular note, in a typical interactive video application, the need for providing rapid feedback to the user, in terms of updated images, is substantially more important than the need for providing high-quality images, particularly while the user is scanning/searching for a particular view of an object. In general, once a user finds the desired view, the user is willing to wait for a high-quality view of the object, but until the desired view is found, the user does not want to wait for intermediate views to be displayed beyond the degree necessary to determine that the displayed view is not the desired view.

It is significant to note that each of the mosaics of the object is substantially independent of each of the other mosaics, in contrast to conventional progressive encoding techniques that provide progressively more detail to an image as time allows. Such conventional techniques provide increasing levels of detail/resolution within a single recording of the image. For example, a first level of a recording of an image may be encoded using a particularly high quantization factor, producing a relatively low-resolution image. A second level of the recording may be performed using a lower quantization factor, and recorded as a set of differential measures relative to the first level of the recorded image. A third level of the recording may again be performed using a next lower quantization factor, and recorded as a set of differential measures relative to the second level of the recorded image, and so on. As each level of the recording is decoded and displayed, each ‘block’ of the image appears to be progressively improved in detail. In a conventional ‘increasing detail with time’ embodiment, the display/creation of an image at a given resolution requires the presence of each of the lower resolution recordings of the image.

It is also significant to note that in the conventional progressive encoding approach, each of the encoding levels must differ from the prior level in the same selected resolution parameter that provides the increased detail. For example, if a ‘base level’ (least resolution) encoding has a particular parameter that is enhanced at the next level of decoding, each subsequent level uses this same parameter to provide increasingly enhanced images.

In a preferred embodiment of this invention, by recording different mosaics at different resolutions, rather than conventionally recording a single copy of a video with different levels of resolution within the single recording, such as a “progressive” encodings with increasing detail provided at each successive levels of the (single) encoding of the video, each mosaic of this invention is an independently renderable recording of the video. That is, as contrast to the decoding of a progressive recording that relies on the information provided by the decoding of each prior level of the recording, in a preferred embodiment of this invention, the decoding of any particular mosaic is not dependent upon the decoding of any other mosaics to enable the rendering of this mosaic. Of particular note, this independence of encodings allows, for example, one of the mosaics to vary in spatial resolution, another in temporal resolution, another in a combination of a variety of types of resolutions, and so on.

FIG. 2 illustrates an example system diagram for the presentation of an interactive video application in accordance with aspects of this invention. In this example system, a client-server arrangement is illustrated, wherein a server 210 is configured to provide videos to a client 250 via a communications link 215-255. In this example system, the client 250 identifies a desired video, and the server 210 accesses a video database 220 to obtain the requested video.

In accordance with an aspect of this invention, the system is configured to facilitate rapid access to any part of the requested video, thereby making it particularly well suited for interactive video applications wherein the displayed information is highly dependent upon actions of the user/viewer, such as directives to change the user's viewing angle.

To receive the user's directives, the client 250 includes an input element 270, such as a touchpad, a joy-stick, a mouse, etc. that allows the user to scan to any desired frame in the video. This scanning control may be implemented as a “scrub” bar, or “speed” bar, as detailed above, or, in the case of smart-phones and the like, may be implemented by detection of a “sweep” of the user's finger across the displayed image, the direction of the sweep indicating the desired direction of the scan, and the speed or duration of the sweep indicating the desired magnitude of the sweep. As each image along the scan is received, it is displayed, as time allows. The display of each image provides feedback to the user to facilitate an efficient scan to a desired image/view in the video.

To facilitate rapid feedback to the user while the user is scanning the video for a desired image/view in the video, the system of this invention includes multiple recordings of the images in the video (mosaics), each at a different level of resolution, as detailed above. In the example embodiment, a high-resolution mosaic 222 is recorded, as well as a medium-resolution mosaic 224, and a low-resolution mosaic 226, although any number of mosaics at different levels of resolution may be stored for each video in the video database 220. One of skill in the art will recognize that the number of different mosaics may be dependent upon the particular object being recorded, the total number of images of the object, the intended duration of a presentation of the object, and so on.

Because each image in the low-resolution mosaic 226 can be expected to take substantially less time to download and display, as detailed above, these images will preferably be downloaded for rapid display on the client 250 as the user is scanning through the video. As the user's scanning slows down, time may be available to download and display images from the medium-resolution mosaic 224, and when the scanning ceases at a desired frame, the image at the desired frame may be downloaded and displayed from the high-resolution mosaic 222. As each higher resolution image is displayed, it replaces the lower resolution image (as contrast to conventional progressive decodings that progressively enhance each of the lower resolution images).

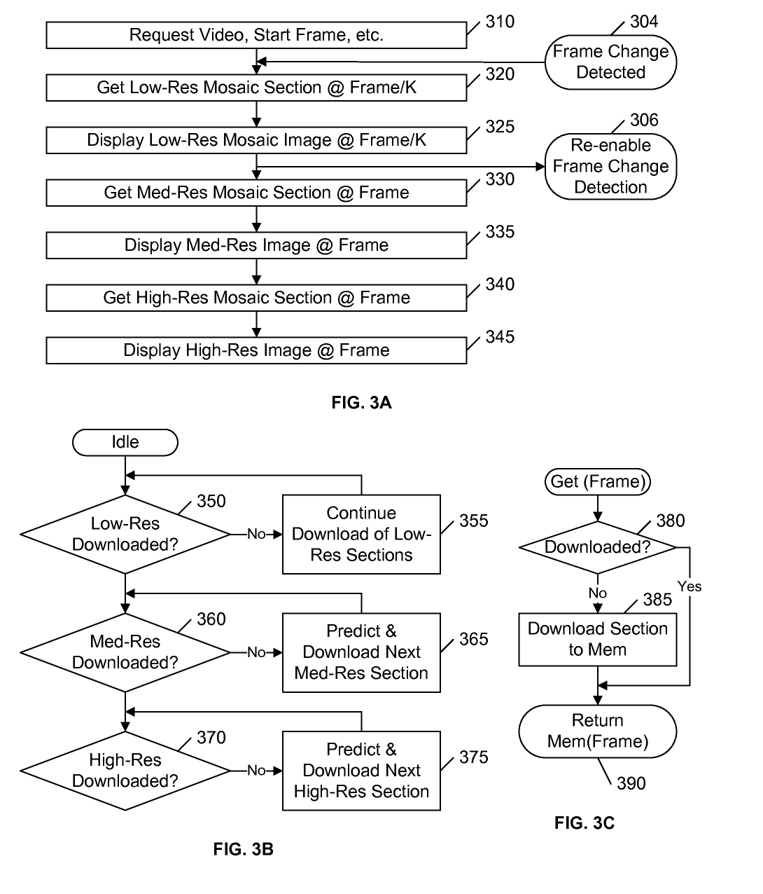

FIGS. 3A-3C illustrate example flow diagrams for achieving the rapid display of low-resolution images while the user is scanning, and a display of increasingly higher resolution images as time allows.

FIG. 3A illustrates the basic sequence of presenting increasingly higher resolution images as time allows. For ease of presentation and understanding, this process will initially be presented for the situation in which the user does not interact with the system to change the frame being presented by the system, followed by the situation of the user interacting with the system to change frames.

At 310, the client requests the video, and optionally provides a starting frame number and other options. For ease of reference, the frames are referenced in terms of the frame numbers of the high-resolution mosaic. That is, if the high-resolution mosaic includes N frames, and the desired starting frame is at the center of the mosaic, the starting frame number will be N/2. If the video is intended to provide a continuous (e.g. 360°) view of the object, a modulo function is used to link the last frame to the first frame. That is, in the subsequent presentation, if the requested frame is the N+M^{th} frame, the frame number will be changed to a request for the M^{th} frame.

In response to the request, the server locates the video and transmits a section of the low-resolution mosaic corresponding to the requested (or default) starting frame, at 320. As detailed further below, the mosaic section that is downloaded will typically include multiple frames that are spatially related to the requested frame; however, the transmitted section may also only include one frame. As noted above, in the example embodiment, the low-resolution mosaic is recorded at a lower temporal resolution than the high-resolution mosaic, and thus does not have as many frames as the high-resolution mosaic. Accordingly, if the ratio of the number of high-resolution frames to the number of low-resolution frames is “K”, and the requested (high-resolution) frame number is “F”, the corresponding low-resolution frame number will be F/K.

Because at this point, it is unknown whether the user will immediately select a different frame or wait before such a selection, the received low-resolution image is displayed, based on the data contained in the F/K frame of the low-resolution mosaic, at 325.

Assuming that the user does not request a different frame when the low-resolution image is displayed, the system proceeds to present higher resolution images corresponding to the requested frame. At 330, an image from the medium-resolution mosaic is obtained. In this example embodiment, the medium-resolution mosaic is at the same temporal resolution as the high-resolution mosaic, and a transformation of the frame number F is not required.

Also in this example embodiment, since the user has been presented an image (at F/K in the low-resolution mosaic) that may not exactly correspond to the desired image (at F in the medium and high resolution mosaic), it is likely that the user may ‘fine-tune’ the identification of the frame when the medium-resolution image is presented. Accordingly, in this example embodiment, the downloaded section will likely include one or more medium-resolution frames that are spatially adjacent to the request frame F. In a one-dimensional mosaic, for example, frames F−1, F, and F+1 may be included in the response to a request for frame F; in a two-dimensional mosaic, a 3×3 array of frames surrounding the frame F may be included.

Since a significant amount of overhead is typically associated with requesting a download from a server, requesting multiple images via a single request for a section of multiple frames, or automatically downloading multiple frames in response to a request for a single frame, provides a degree of efficiency when other of the images in the section are likely to be requested for display. Optionally, the number of frames included in a section may be based on the size of each frame relative to the overhead burden, or relative to some ‘optimal’ download size. In like manner, the number of frames in a section may be based on a likelihood of requesting another frame in the vicinity of the requested frame, which will typically be dependent upon the aforementioned temporal resolution of the low-resolution mosaic. These and other factors may be used to select the frames to include in each section. For example, if it is determined that most users, or the particular current user, generally initially travel in a particular direction while searching for a desired view, the section may be configured to include more frames in that direction than in the opposite direction (e.g. frames F(i−1), F(i), F(i+1), F(i+2) if the user typically moves in the direction of increasing i).

After displaying the medium-resolution image at 335, and assuming that the user does not request a different frame, the system proceeds to obtain the frame F from the high-resolution mosaic, at 340, and displays it, at 345. Because the high-resolution frame F is likely to be large enough to warrant the overhead of the request, and because the user will have had the opportunity to fine tune the selection of the desired frame based on the medium-resolution images, the downloaded section will often only include the requested frame.

One of skill in the art will recognize that the above described processes and features are merely presented as examples, and may be modified as desired. For example, because the low-resolution frames are likely to be small, a section of multiple frames may always be downloaded when the low-resolution frame is requested, at 320. In like manner, the downloading of multiple frames may be eliminated altogether, or the choice of whether to download a section of multiple frames at any level may be based on the size of the requested frame and its spatially adjacent frames.

In some embodiments of this invention, the downloadable sections of a mosaic may be predefined and stored as such in the mosaic. For example, a two-dimensional mosaic may be partitioned into a set of 3×3 arrayed frames, and each of these partitions may be encoded and stored as a predefined section. Such predefining and pre-encoding allows for a more efficient response from the server 210, because the selection of frames to include in the section and subsequent encoding in response to each request is eliminated. In like manner, at the client 250, if the size and shape of the sections from a particular mosaic are predefined, the processes used to decode and display the image can be optimized to rapidly display the requested image.

In like manner, regardless of whether the particular sections of a mosaic are predefined and pre-encoded, the encoding and decoding processes may be optimized with regard to the intended purpose of this invention. That is, even though the invention is presented using the example of a section comprising individual frames (F(i−1), F(i), F(i+1), etc.), the downloaded data need not be composed of individual frames, per se. In response to a request for frames F(i−1), F(i), F(i+1), for example, a convention differential encoding, such as MPEG, may be used wherein frame F(i) is encoded as the base frame, and each of F(i−1) and F(i+1) are encoded as predicted frames, based on their differences from frame F(i). Such differential encoding is particularly well suited for mosaics with fields having overlapping images, such as illustrated in FIG. 1C.

One of skill in the art will recognize that other encoding and decoding techniques may be used to optimize the transmission and subsequent display of the sections of each mosaic, and will recognize that different optimization techniques may be used for each different type of mosaic. For example, a mosaic with low temporal resolution may not benefit from the aforementioned differential encoding because the adjacent frames are not likely to have a large overlap in image area. In like manner, even though, as discussed above, each mosaic is independent of each other, and progressive encoding techniques are not used between mosaics, such techniques may be used in the encoding of frames within a given mosaic. That is, the encoding of frames within a given mosaic is not constrained by any aspect of this invention, thereby allowing the encoding of each mosaic to be optimized for its particular characteristics. For example, frames of a low resolution mosaic of an object may be encoded as a simple ‘run length’ encoding, avoiding the processing time at the client for decoding a more complex encoding, such as MPEG; however, the high resolution mosaic of the same object may be encoded using any of a variety of techniques that facilitate the efficient transmission and display of high resolution images.

One of skill in the art will also recognize that the techniques used to display the images from the different recordings may vary depending upon the particular device or video driver configuration. For example, the display driver may support multiple levels of image memory, with control features for enabling or disabling a particular level of the image memory. That is, the low-resolution image may be stored in a first level of the image memory, the medium-resolution image in a second level, and the high-resolution image in a third level, each level being selectively enabled via a “transparent/opaque” switch. While the system is waiting for a higher level image to be updated, the image memory at that level is set to “transparent” so that the previously loaded lower resolution image is displayed; when the higher level image is ready for display, the image memory is set to “opaque”, blocking the display of the lower level images. In this manner, the user is always provided an image, instead of a blank screen or a changing screen while the new image is being created.

The above presentation describes the operation of the system while the user is not interacting with the video to select a new frame. A variety of techniques may be used to support the rapid display of images as the user interacts with the displayed images, one of which is illustrated in FIG. 3A.

In this embodiment, an interrupt-like scheme is used to cause the process of FIG. 3A to branch back to the display of low-resolution images when a change of frame occurs, at 304. In this embodiment, the combined processes 320 and 325 are defined so as not to be subject to interruption when a frame change occurs. For example, upon entry to process 320, the frame-change interrupt mechanism may be disabled, then re-enabled at 306, after completing the display of the low-resolution image. Thereafter, at any point in the processes 330 through 345, a frame change 304 will cause the system to effectively restart at 320. (As is common in the art, within such processes 330-345, certain sub-processes may be protected from interruption, but when these sub-processes complete, the system will branch to 304.) Alternatively, the system may be configured to only respond to frame-change interruptions between each of the illustrated processes 325-345.

When a frame change 304 is detected, the system immediately proceeds to obtain the low-resolution frame corresponding to the newly requested frame F, by requesting a section that includes frame F/K from the low-resolution mosaic at 320. As illustrated in FIG. 3C, if, at 380, the frame has already been downloaded, and is available from the memory of the device, the data from the memory may be used, at 390; otherwise the requested frame is downloaded to the memory, at 385, and used, at 390. If the download data includes a section of multiple frames, each of the frames is correspondingly stored in the memory, so that a subsequent request for one of these frames will be satisfied from the memory, rather than incurring the delays associated with downloading the frame from the server.

The obtained low-level image from frame F/K is displayed, at 325, replacing the higher level images, if any. Note that in the above example embodiment of multiple levels of image memory, this ‘replacement’ may be achieved by merely setting the higher level images to the ‘transparent’ state. Also, if the lower resolution image is already in the image memory (i.e. the (prior F)/K frame is the same as the (new F)/K frame), the data in the lower image memory need not be updated.

Upon completing the display of the low-resolution image at 325, the detection of a frame-change is re-enabled, at 306. If the user has interacted with the system so as to have identified a different frame, this change is detected, at 304, and the low-resolution image corresponding to this different frame is obtained, at 320, and displayed, at 325.

If the user has not yet identified a different frame from the new frame F, the system proceeds to obtain the medium-resolution image for the new frame F, at 330. As in obtaining the low-resolution image, if the frame F of the medium-resolution mosaic has already been downloaded to memory (e.g. by being a member of a previously downloaded section, the data in the memory is used in lieu of requesting another download of that frame. At 335, the medium-resolution image of the frame F is displayed.

As in the display of the low-resolution image, if this image is already in the second level of the image memory (as may happen if the user scans back-and-forth quickly, before the second level image has been replaced), the medium-level image may be redisplayed by merely setting the high-level image memory to the ‘transparent’ state.

If the user has not changed the desired frame while the system has been obtaining and displaying the medium-resolution image at frame F, the system proceeds to obtain 340 and display 345 the high-resolution image from the frame F of the high-resolution mosaic. As in the case of the low and medium resolution images, if the frame or image is already in the device memory, it need not be downloaded from the server. Also as in the processing of the medium resolution image, if the user selects a different frame while the high-resolution frame F is being obtained or the corresponding image displayed, the system will detect this frame change 304, and proceed to obtain and display the lower-level image corresponding to the different frame, at 320.

FIG. 3B illustrates a background process that may be performed while the system is “idle”, such as while the user is viewing a requested high-resolution image and not interacting to change the frame being viewed. As with the process of FIG. 3A, if the user initiates a frame change, the process of FIG. 3B will be interrupted, and the process will continue at 304 in FIG. 3A.

If, at 350, the low-resolution mosaic has not yet been completely downloaded, the download will be restarted, at 355. In like manner, if, at 360, the medium-resolution mosaic, and then at 370, the high-resolution mosaic, has not yet been completely downloaded, the downloads will be restarted, at 365 and 375 respectively.

In the case of the low-resolution mosaic, because it is likely to be relatively small, the download may merely be a sequential download until all of the frames are downloaded. In the case of the medium and high resolution mosaics, the system may be configured to predict which frames are most likely to be requested by the user, based on the user's prior actions, or other heuristics.

One of skill in the art will recognize that this background process is optional, and is merely performed so that subsequent views can be presented without waiting for the frames to be downloaded from the server. If, on the other hand, the user is billed for services based on the quantity of data downloaded, this background process would likely be limited to avoid some or all of the downloads 355, 365, 375 until the frames are actually requested. In like manner, the order of downloading during the idle period need not be sequential, from low to high resolution. Predictive techniques may be used to select from which mosaics to download sections.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the processes of FIGS. 3A-3C, above, are presented using a client-controlled, or “pull” paradigm, wherein the client initiates each request for a download from the server. One of skill in the art will recognize that the principles of this invention may be embodied using a server-controlled, or “push” paradigm, wherein once the server receives the initial request from the client, subsequent downloads are sent from the server with minimal client actions being required. For example, the server may autonomously perform the processes 320, 330, and 340 (as well as the optional process of FIG. 3B), and the client may only need to notify the server, at 304, when the user desires a different frame. These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of a combination of hardware portions (e.g., including discrete and integrated electronic circuitry) and software portions (e.g., computer programming).

f) hardware portions may include a processor, and software portions may be stored on a non-transitory computer-readable medium, and may be configured to cause the processor to perform some or all of the functions of one or more of the disclosed elements;

g) hardware portions may be comprised of one or both of analog and digital portions;

h) any of the disclosed devices or portions thereof may be combined together or separated into further portions unless specifically stated otherwise;

i) no specific sequence of acts is intended to be required unless specifically indicated; and

j) the term “plurality of” an element includes two or more of the claimed element, and

does not imply any particular range of number of elements; that is, a plurality of elements can be as few as two elements, and can include an immeasurable number of elements.

We claim:

1. A client device comprising:
an input element that receives user input,
a communication element that communicates with a server,
a memory element that stores data received from the server,
a display element that provides images based on the data, and
a controller that is configured to:
request a view of an object from the server, based on the user input,
receive a section of a first mosaic of the object corresponding to the view at a first resolution from the server,
display a first image on the display element based on one or more frames of the section of the first mosaic,
receive a section of a second mosaic of the object corresponding to the view at a second resolution from the server, and
display a second image on the display element based on one or more frames of the section of the second mosaic, replacing the display of the first image.

2. The client device of claim 1, wherein the controller is further configured to:
receive an other user input that includes a new identification of another desired view of the object,
request another view of an object from the server, based on the other user input,
receive an other section of the first mosaic from the server,
display a third image on the display element based on the other section of the first mosaic, replacing the display of the second image,
receive an other section of the second mosaic from the server based on the other user input, and
display a fourth image on the display element based on the other section of the second mosaic, replacing the display of the third image,
wherein if another user input is received that includes another identification of a further desired view of the object before the other section of the second mosaic is received, the receiving of this other section and the display of the fourth image are terminated.

3. The client device of claim 1, wherein the controller is further configured to:
receive a section of a third mosaic of the object at a third resolution from the server, and
display a third image on the display element based on the section of the third mosaic, replacing the display of the second image,
wherein the first and second resolutions differ by a first resolution parameter, and the second and third resolutions differ by a second resolution parameter that differs in type from the first resolution parameter, and
the first and second resolution parameters include at least two of: a spatial resolution parameter, a temporal resolution parameter, and a pixel quality parameter.

4. The client device of claim 1, wherein each section of each mosaic includes one or more image frames, and at least one section of at least one of the mosaics includes a plurality of image frames that are spatially adjacent.

5. The client device of claim 4, wherein the plurality of frames is based on a spatial difference between the desired view and at least one prior desired view.

6. The client device of claim 1, wherein the controller is configured to receive other sections of at least the first and second mosaics without a specific request from the user.

7. The client device of claim 6, wherein the other sections of the at least first and second mosaics are selected using a prediction based on prior input from one or more users.

8. A server comprising:
a first communication element that communicates with a client,
a second communication element that communicates with a database, the database including a plurality of mosaics corresponding to an object, each of the mosaics of the plurality of mosaics having a different resolution,
a control element that:
receives a request for a view of the object via the first communication element,
obtains a section of each of the mosaics based on the request for the view via the second communication element, and
communicates the section of each of the mosaics via the first communication element in increasing order of resolution, such that the section of the mosaic having a lowest resolution is communicated first, and the section of the mosaic having a highest resolution is communicated last.

9. The server of claim 8, wherein the control element is configured to terminate obtaining and communicating the sections upon receipt of an other request for an other view of the object.

10. The server of claim 9, wherein receipt of the other request causes the control element to:
obtain an other section of each of the mosaics based on the other request, and
communicate the other section of each of the mosaics via the first communication element in increasing order of resolution, such that the other section of the mosaic having a lowest resolution is communicated first, and the other section of the mosaic having a highest resolution is communicated last.

11. The server of claim 8, wherein the resolutions of at least two mosaics differ by a first resolution parameter, and the resolutions of at least two mosaics differ by a second resolution parameter that differs in type from the first resolution parameter, and
the first and second resolution parameters include at least two of: a spatial resolution parameter, a temporal resolution parameter, and a pixel quality parameter.

12. The server of claim 8, wherein each section of each mosaic includes one or more image frames, and at least one section of at least one of the mosaics includes a plurality of image frames that are spatially adjacent.

13. The server of claim 12, wherein the plurality of frames is based on a spatial difference between the desired view and at least one prior desired view.

14. The server of claim 8, including a processing element that receives a first mosaic of the plurality of mosaics at a first resolution and creates each of the other mosaics of the plurality of mosaics based on the first mosaic.

15. The server of claim 8, wherein at least one mosaic includes a first type of resolution parameter and at least one other mosaic includes a second type of resolution parameter, and the first and second types of resolution parameter include two of: a spatial resolution, a temporal resolution, and a pixel quality resolution.

16. A non-transitory computer readable medium that includes a program that, when executed by a processor, causes the processor to:
create a first mosaic at a first resolution that includes a plurality of frames corresponding to images of an object from different views;
create a second mosaic at a second resolution from the first mosaic, the second resolution being less than the first resolution; and
storing the first mosaic and the second mosaic at a database server that enables retrieval of a section of each of the mosaics corresponding to a select view of the object at a select resolution.

17. The medium of claim 16, where the program causes the processor to create a third mosaic at a third resolution from one of the first mosaic and the second mosaic, wherein the second mosaic includes a first type of resolution, the third mosaic includes a second type of resolution, and the first and second types of resolution include two of: a spatial resolution, a temporal resolution, and a pixel quality resolution.
